(19) United States
(12) Patent Application Publication
(10) Pub. No.: US 2010/0200515 A1
(43) Pub. Date: Aug. 12, 2010

(54) TREATMENT OF THE REFINERY WASTEWATER BY NANO PARTICLES OF TIO2

(75) Inventor: Javad Saien, Hamadan (IR)

Correspondence Address: CHOOBIN & CHOOBIN CONSULTANCY L.L.C;Barry Choobin, Green Community, Building 3, Ground Floor, Dubai Investment Park, P.O Box 212880, Dubai, AE

(73) Assignee: Iranian Academic Center for Education, Culture & Research (ACECR), Kermanshah (IR)

(21) Appl. No.: 12/766,858

(22) Filed: Apr. 24, 2010

Related U.S. Application Data
(60) Provisional application No. 61/290,047, filed on Dec. 24, 2009.

(51) Int. Cl. C02F 1/32

(52) U.S. Cl. 210/742; 210/151; 210/149; 210/85; 210/748.14; 210/743; 977/903; 977/773

(57) ABSTRACT

The embodiments herein relate to a photocatalytic reactor system and photo-degrading method for eliminating organic and high molecular oil contaminant (or pollutants) from industrial wastewater. A more economical and stable titanium dioxide (TiO₂) having a diameter of 21±10 nm is used as the photocatalyst. Method and system of present invention is highly efficient, compatibles with the environment and does not require secondary or additional treatments. In one embodiment, an optimal and very low catalyst concentration (100 ppm) is used for high degradation of the pollutant which is irradiated for utmost 120 min using UV light. This has an industrially interest as this method is considered as an alternative or synergetic process for biological degradation, having high residence times, required to provide significant COD removal. The analysis of the contained materials showed that the efficiency of the applied degradation system is high for all the identified present organic pollutants.

### CROSS-REFERENCE TO RELATED APPLICATION

This application claims the priority under 35 USC 119(e) of U.S. Provisional Application Ser. No. 61/290,047 filed on Nov. 18, 2009 which is incorporated by reference herein.

### SPONSORSHIP STATEMENT

The present invention for international filing is sponsored by Iran Nanotechnology Initiative Council.

### BACKGROUND

1. Technical Field

The embodiments herein generally relate to the field of industrial wastewater treatment method and particularly to a method of using photocatalysts. The embodiments herein more specifically relate to a method of using nano particles of TiO₂ as photocatalyst to remove an industrial pollutant from the refinery wastewater body before releasing back into the environment.

2. Description of Related Art

The occurrence of oil and corresponding contaminant in the water sources began with the production and utilization of petroleum and its products in refinery industries. The earlier common practice used in many industries is to discharge the waste directly into rivers and bare surface leading to a rise in a pollution level of a surrounding environment. Presently with strict regulation and concern for the environment, the wastewater treatment is mandatory for such industries. The type and concentration of the pollutants in a given refinery's effluent depends on the chemical make-up of the crude oil and the processes used to make the final products.

Refineries use large amounts of water in the refining process and as a cooling agent. This water picks up waste oil and impurities during the refining process. The impurities inherently present in the crude oil itself include heavy metals, sulfides, aliphatic and aromatic hydrocarbons, while those created during the refining process include cyanides, dioxins and furans. All these chemicals are toxic to an aquatic life at very low concentrations. The major problem of the oil-contaminated wastewater is associated with its suitable disposal. The refinery wastewater has been marked as one of the key environmental pollutants with great effect on the biodiversity.

Industries require large quantity of water for various industrial operations. For this reason and others, an economical industrial wastewater treatment method is important. Thus treated industrial wastewater is recycled and consequently helps in preserving the existing limited water resources. The industrial wastewaters, when returned to the environment untreated for agricultural purpose, or for animal consumptions or others, it causes considerable environmental problems. The common treatment of wastewater is planned based on different mechanical, biological, chemical, and physical processes.

All the related prior art approaches include limitations and spending large amounts. Therefore, carrying out research around new technologies of wastewater treatment to degrade complex high molecular weight compounds and simple compound like water and carbon dioxide without reducing water quality is a fundamental need.

There are several methods of treating wastewater from such industries but still an improved and effective method with better effluent quality is required for current technology.

The above mentioned shortcomings, disadvantages and problems are addressed herein and which will be understood by reading and studying the following specification.

### OBJECTIVE OF THE EMBODIMENTS

The primary object of the embodiments herein is to provide a photocatalytic reactor and a method for the treatment of industrial wastewater specifically refinery wastewater by photooxidation.

Another object of the embodiments herein is to develop a method for the treatment of industrial wastewater using a nano photocatalyst for wastewater treatment specifically, TiO₂ nano particles.

Yet another object of the embodiments herein is to develop a method for the treatment of industrial wastewater using UV irradiation for the activation of a photo catalyst in a special photoreactor along with optimized operating conditions of pH, temperature and concentration of photocatalyst to obtain the best results without affecting the quality of the water.

These and other objects and advantages of the embodiments herein will become readily apparent from the following detailed description taken in conjunction with the accompanying drawings.

### SUMMARY

Briefly stated, the embodiments herein relate to a photo-reactor system employing a photocatalyst and a photo-degrading method for eliminating an organic and high molecular oil contaminant (or pollutants) from industrial wastewater. The photocatalyst used is nano particles of titanium dioxide (TiO₂) having a diameter of 21±10 nm. The method and the system of the embodiments herein are highly efficient, compatible with the environment and do not require any secondary or additional treatments. In one embodiment, the wastewater is treated in a photoreactor with a low concentration of nano particles of titanium dioxide for the higher degradation of the pollutants. Thus the complete elimination of the pollutants, the pathogenic agents and the other harmful materials in wastewater is achieved. Thus treated water can recycled.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 shows a block diagram of an applied photocatalytic reactor used for treating the contaminants in a refinery according to one embodiment herein.

FIG. 2 shows a comparison of the conversion rate of pollutants in the presence of UV light and in the darkness.

FIG. 3 shows comparison of the conversion rate of pollutants with/without nano TiO₂.

FIG. 4 shows the changes in decomposition and conversion rate of pollutants with respect to time and with different concentrations of nano TiO₂ particles.

FIG. 5 shows the changes in decomposition rate of pollutants conversion with respect to time and with different pH values.

FIG. 6 shows the changes in decomposition and conversion rate of pollutants with respect to time and with different temperatures.

FIG. 7 shows a range of GC analysis before and after treatment.

Although specific features of the embodiments herein are shown in some drawings and not in others. This is done for convenience only as each feature may be combined with any or all of the other features in accordance with the embodiments disclosed herein.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a photocatalytic apparatus and a method for photo-degradation and elimination of organic and oil pollutants from industrial or specifically refinery wastewater. Refinery waste water sample consists of both aliphatic and aromatic organic compound with different functional group which includes methyl tetra butyl ether, phenol, tetra methyl phenol, naphthalene, tetradecacne, 4-cholro 3 methyl phenol and others. A sample of wastewater is analyzed using photoreactor and nano photocatalyst of TiO₂ in present of UV radiation for photo-degradation of high molecular weight pollutant found in water from industrial effluents. Nano TiO₂ significantly improves the degradation efficiencies of various contaminants in wastewater. Photocatalytic treatment of water is an effective method for degradation of pollutants and photo-destruction of organic pollutants.

The parameters affecting the process includes UV radiation, concentration of nano photocatalyst, pH of solution and its temperature and each of the foregoing parameters is optimized in the realm of laboratory facilities.

The embodiments herein provide a highly efficient, more economical and an environmentally compatibles photoreactor system and method for water treatment without requiring additional or any secondary treatment. Photo-chemical approaches are entitled with a considerable attention by scientists and engineers. The free radicals released during UV radiation have the oxidation quality for photo-catalytic effect.

A nano particle of titanium dioxide (TiO₂) is the most effective photocatalyst used for photo-degradation and elimination of the pollutant materials, bacteria, and other harmful materials in water. Nano TiO₂ of the embodiments herein is highly photoreactive, cheap, non-toxic, chemically and biologically inert, and photostable.

The embodiments herein provide a conic body circulating type photocatalytic reactor. The performance of the reactor has the advantage of providing the required flow-rate at the suction point of circulating pump from the wide top opening portion of the reactor. The circulating flow provides a unique solution and inhibits photocatalyst sedimentation. Also the UV lamp for light source is exposed directly into the solution leading to achieve a perfect and uniform irradiation.

The reactor performance has the advantages of uniform upward mixing with a circulating stream, provided by a pump. There is no dead-zone in the space of the reactor. Conventional cylindrical reactors usually suffer from a low circulating flow-rate due to weak suction flow, coming from top of the reactor and also due to the presence of the dead zones. All the reactor content materials and catalyst particles are uniformly irradiated to generate the hydroxyl radicals for degradation.

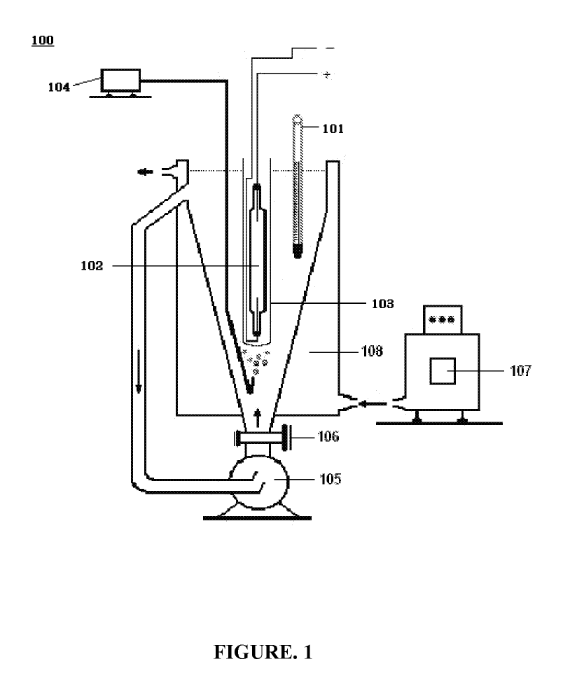

In one of the embodiments, a photoreactor for refinery wastewater treatment of 850 ml capacity is constructed using Pyrex and having double-layers. FIG. 1 shows the photocatalytic reactor 100 of the present invention having conical and funnel shaped main frame with vertical positioning having its wide opening at the top and its narrow opening towards down (entry place for circular process) into a circulating pump 105 and is regulated by a valve 106. In the outer surrounding jacket 108, a water coolant is circulated for regulating temperature of the photoreactor. The UV irradiation source is a mercuric vapor lamp 102 with the nominal power of 400 W. The UV source is surrounded by a quartz tube 103. The circular stream stirs and equals the environment inside the reactor to ensure uniform distribution of light of all solution particles inside the reactor. The photoreactor is provided with a thermometer 101, micro-air compressor 104, and thermostat 107.

In order to use the reactor, a known feed amount of real refinery wastewater with a known amount of TiO₂ concentration was prepared. The pH was adjusted to the desired value by means of a pH meter using dilute H₂SO₄ and NaOH solutions. The feed was then transferred to the photoreactor 100 and after adjusting temperature using the thermometer 101, the lamp 102 was switched on to initiate the degradation. Since the photocatalysis is sustained by a ready supply of dissolved oxygen, air was supplied to the reaction system at a constant flow-rate using a micro-air compressor 104.

During each experiment, circulation of suspension was maintained to keep suspension homogenous and to have uniform photon receiving from UV lamp. Meantime the coolant water, flowing in the outer surrounding jacket 108, kept the temperature constant. Samples were taken at regular time intervals in order to measure the COD of the reactor content.

Nano TiO₂ a P25 type having mixtures of nano anatase and rutile TiO₂ with highest activity is purchased from Plasma Chem Gmb Co. The average diameter of the nano photocatalyst TiO₂ is 21±10 nm with 99.9% purity. The photocatalyst used in the embodiment herein has a good semi-conductivity quality to perform the process of decomposition of a contaminant by a photooxidation mechanism. TiO₂ as a photocatalyst of the embodiment herein is of low cost, chemically stabile, nontoxic and has high photocatalytic reactivity.

The effective factors influencing the decomposition of the real refinery wastewater pollutants using UV/TiO₂ approach are studied. This task is for specifying the effectiveness rate and profitability of this method in the refinement of the considered wastewater and for finding an optimal reaction conditions. The effective factors influencing the treatment method includes UV light, presence of nano particles of TiO₂ as photocatalyst, its concentration, pH of solution and temperature.

### Example 1

### Effect of UV Light

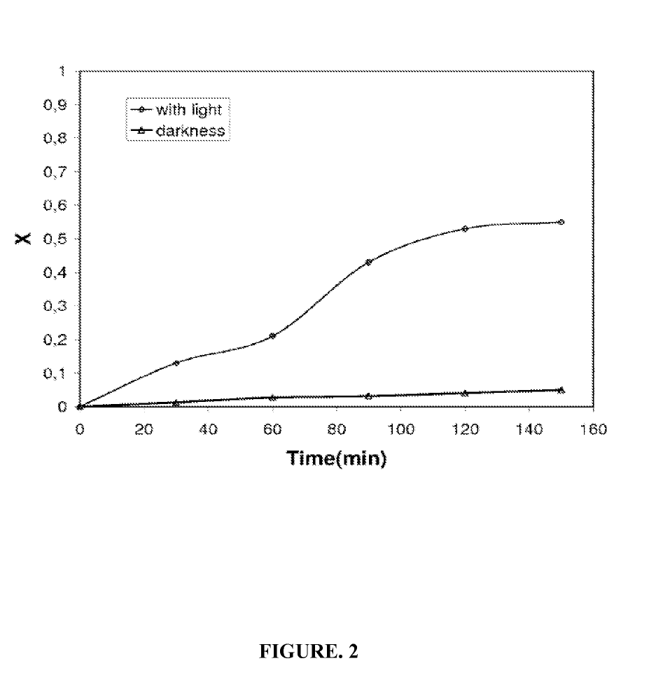

The photo-degradation effect of UV light on wastewater sample is understood by comparing the effect in the presence and the absence of UV light. The effective role of UV light in the degradation of the wastewater pollutants is estimated by conversion factor (X), which is negligible in the absence of light, due to lack of production of active hydroxyl radical. When, the same sample was irradiated with UV light, the conversion factor (X) for the same irradiation time increases to 0.55, due to the generation of very strong oxidizers, the active hydroxyl radicals. FIG. 2 shows that the conversion factor in the reaction mixture in dark situation is ignorable when compared to that in the UV light radiation. The irradiation wavelength is within 280 nm-550 nm and maximum irradiation intensity being 365 nm.

### Example 2

### Effect of the Presence of the Nano Photocatalyst in the Presence of UV Light and in the Absence of Light

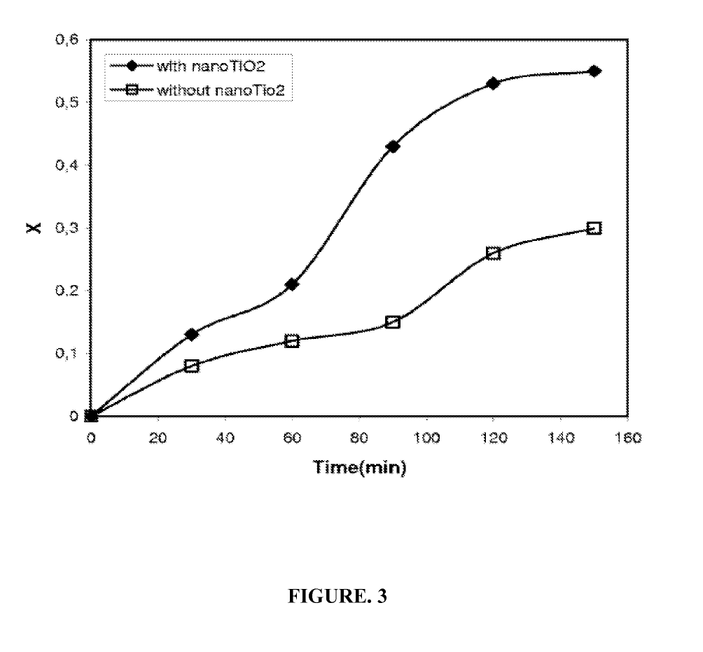

The effect of nano photocatalyst (TiO₂) in the degradation of the organic and oil pollutants in refinery wastewater is tested. The wastewater sample in the absence of a nano photocatalyst and in the presence of light and air current indicates that the conversion factor (X) is about 45% lower compared to the presence of nano photocatalyst (TiO₂) in the wastewater treatment mixture sample and for a light irradiation of about 150 min. FIG. 3 shows the conversion factor (X).

With the purpose of optimizing the concentration of nano TiO₂ as the photocatalyst of photooxidation reaction of the pollutants in the refinery wastewater, a reaction media with a concentration of photocatalyst ranging from 10 to 200 ppm is analyzed. The reason for selecting low-level concentrations is purely economical. The results indicate that the conversion efficiency increased considerably with increased concentration of TiO₂ from 10 ppm to 100 ppm.

The reaction media with the increased concentration exceeding 100 ppm resulted in the considerable mitigation of the conversion efficiency. The reason of such reduction in conversion of pollutants lies in the fact that the effective exposed sides of catalyst surface is increased with the increase in the quantity of photocatalyst and as a result, the conversion efficiency decreases. However, the increased concentration of photocatalyst in the reaction media results in increased turbidity of the reaction media, thereby reducing the intensity of radiation. Therefore, in concentrations exceeding 100 ppm, the effect of mitigated radiation assumes double importance and it is, followed by reduced conversion. In fact, the suitable quantity of TiO₂ depends on two bilateral phenomena, i.e. increased level of catalyst and reduced intensity of the radiation of UV beams.

An optimal and very low catalyst concentration of 100 ppm is noticed to have high degradation. Under the mild optimum conditions, a degradation efficiency of about 80% of the organic pollutants is achieved by applying radiation for nearly 120 min and significant removal is also obtained in much shorter times, i.e., more than about 60 min. This has an industrially significance interest when this method is considered as an alternative or synergetic process for biological degradation, having high residence times, required to provide significant COD removal. The analysis of the contained materials showed that the efficiency of the applied degradation system is high for all the identified present organic pollutants.

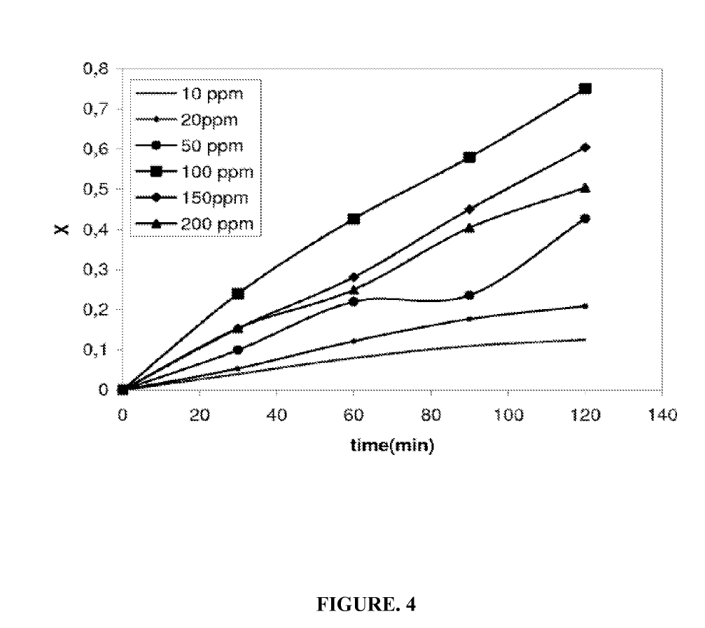

FIG. 4 shows changes in conversion efficiency (X) of pollutants in terms of time and different concentrations of TiO₂ nanoparticles.

### Example 3

### Degradation of Pollutants of Refinery Wastewater under Optimal pH Value

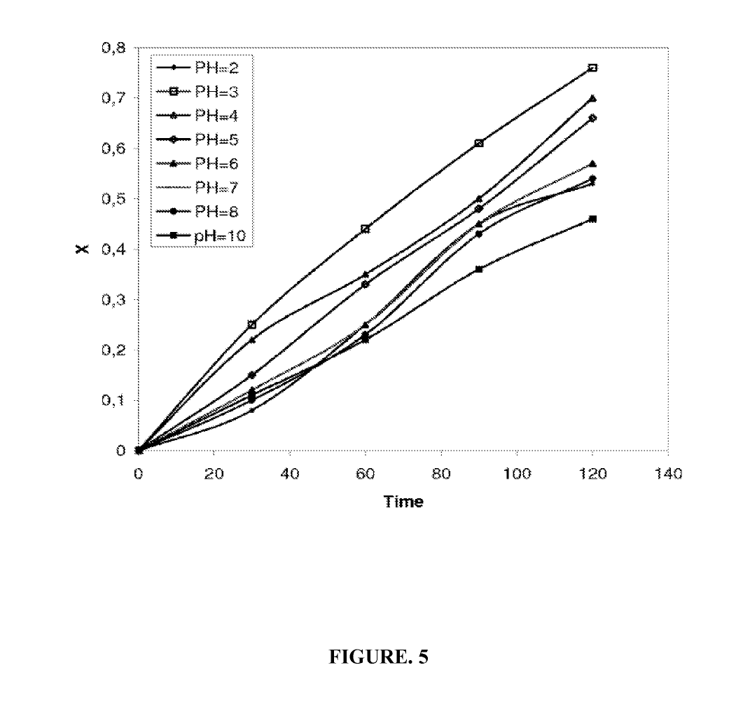

The pH of the solution is regulated on determinate quantities in every test. Range of the pH value tested is 2 to 10. By lowering pH value, the conversion of pollutants gradually increased and this conversion ambit reaches its maximum extent at pH value 3. The conversion of pollutants is considerably decreased on further lowering of pH. The reason of this behavior relates to the surface charge of TiO₂ particles. Therefore, due to the aforementioned reasons, the optimal pH for treating refinery wastewater through UV/TiO₂ photocatalysis is pH 3. FIG. 5 shows changes of conversion (X) of pollutants in terms of time and different range of pH value.

### Example 4

### To Estimate the Effect of Temperature in Degradation Process of Pollutants in Refinery Wastewater

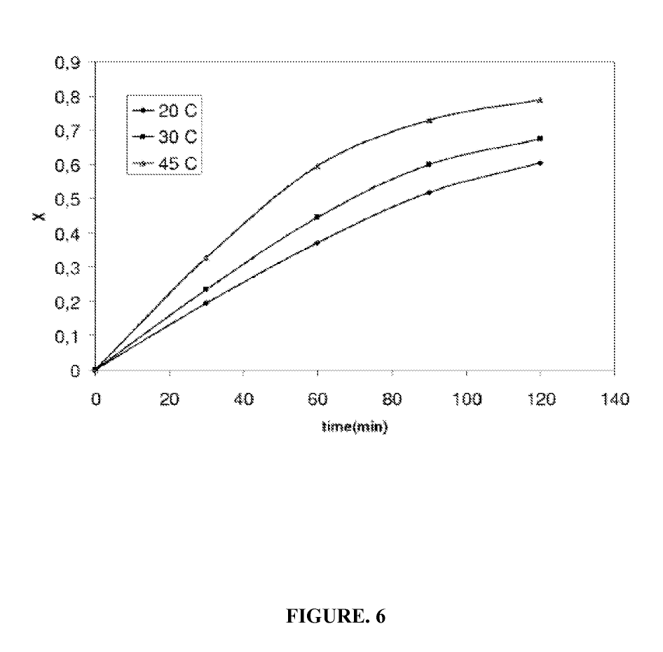

For testing effect of temperature, solutions with a temperature of 20° C., 30° C., and 45° C. are selected. A temperature controller liquid is used to maintain a constant temperature before the start and during the reaction. This test shows the positive effect of increased temperature. The reason for the increased rate of conversion during the increase of temperature is that the process of activation i.e., electron transfer from electrical conduction band to a higher energy level happens with a considerable density. Thus the fixed rate of reaction increases according to Arrhenius equation resulting in an increased rate of reaction at higher temperatures. FIG. 6 illustrates the changes of decomposition of pollutants in terms of time and at different ranges of temperature. As seen at 45° C., a degradation efficiency of about 80% of the organic pollutants is achieved when applying radiation for 120 min and significant removal can also be achieved in much shorter times such as around 60 min or more.

### Identification Analysis

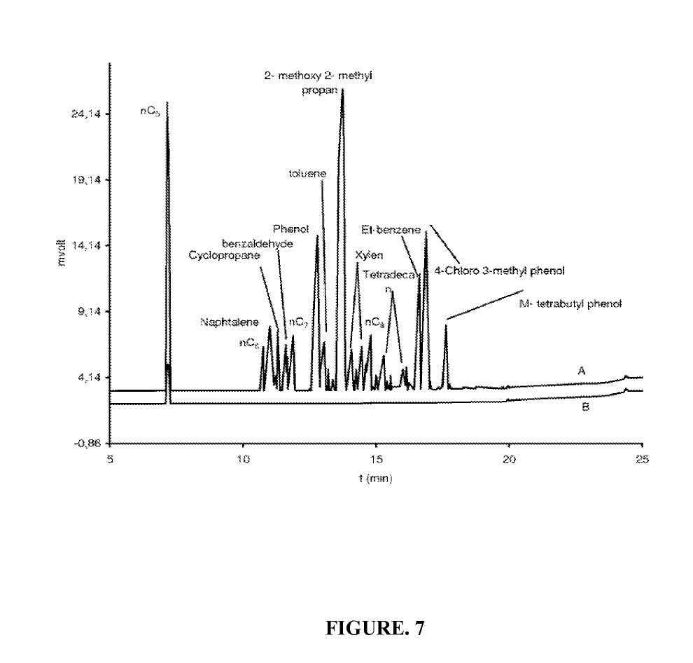

To identify the pollutant compounds in refinery wastewaters, one sample provided before a photocatalytic decomposition and another sample after such decomposition is analyzed through a gas chromatography system. Gas chromatography is equipped with an automatic injection technique to inject the aqueous samples containing vaporized organic materials from a top sample space (GC-Headspace), i.e., from the top empty space of GC equipment. In this regard, FIG. 7 shows a range of GC Analysis before treatment and FIG. 8 shows a range of GC analysis after treatment

The GC analysis of untreated wastewater indicates the presence of the aliphatic compounds, which are generally branched saturated hydrocarbons or non-saturated aliphatic chain hydrocarbons, as well as the presence of aromatic compounds in the samples.

The GC analysis of the treated wastewater shows the relatively complete degradation of the identified compositions, especially aromatic compounds which are resistant against the conventional degradation methods, is degraded by present UV/TiO₂ process in the presence of TiO₂ nanoparticles.

In one embodiment, an organic pollutant of the refinery wastewater is degraded using a very low concentration of catalyst to obtain significant degradation. The wastewater sample is subjected to photocatalytic reaction in a photoreactor using mild concentration of 100 ppm of photocatalyst TiO₂ at pH 3 and temperature of 45° C. The sample is irradiated for 120 min to obtain 80% degradation of organic pollutant. Significant degradation of about 60% can be achieved in much shorter times of irradiation such as 90 min or even at a lesser time of 60 min.

A sample (2.5 mL) from the reaction mixture is taken at regular time intervals (30 min) and the appropriate Chemical Oxygen Demand (COD) was measured by the standard closed reflux and colorimetric method using a COD reactor (HACH) and a spectrophotometer (HACH, DR/2000), calibrated with potassium hydrogen phthalate. In order to identify the present organic compounds in the samples and to compare the efficiency of degradation for different compounds, 10 mL samples of wastewater were taken before and after the degradation and analyzed by means of the headspace technique coupled to a GC/FID (Flame Ionization Detector) system.

### Example 5

### Operation under Optimum Conditions

850 milliliter sample is transferred to the photoreactor. The above mentioned steps and optimum operating conditions are applied leading to the degradation of organic pollutants to harmless materials, i.e. mineralization to carbon dioxide and water (indicated with the criterion of COD). The initial COD value of untreated sample is between 200-220 ppm. This level of COD reduced to about 80-88 ppm after 60 min, and 40-44 ppm after 120 min of treatment. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments disclosed herein can be practiced with modification within the spirit and scope of the appended claims.

What is claimed is:

1. A photocatalytic reactor for carrying out a refinery wastewater treatment consisting of:
a conical funnel shaped main frame constructed in Pyrex having double layer to store a refinery waste water;
a funnel shaped inner layer with a wide opening at top portion and a narrow tube shaped bottom portion opening into a circulating pump;
an outer jacket carrying water coolant arranged around said inner layer to control temperature;
an elongated UV light source enclosed within a quartz tube and provided in said wide opening at top portion for irradiating the waste water;
a micro-air compressor to aerate the wastewater being treated, wherein the wastewater is treated in presence of a photocatalyst in a space around said quartz tube without any dead zone and the pollutants present in the wastewater is irradiated with said UV light.

2. The photoreactor according to claim 1, further comprising a valve provided at said narrow tube shaped bottom portion of said funnel shaped main frame.

3. The photoreactor according to claim 1, further comprising a thermometer provided at said wide opening at top portion.

4. The photoreactor according to claim 1, further comprising a thermostat to control the temperature of the waste water to be treated.

5. The photoreactor according to claim 1, wherein said photocatalyst is nanoparticle of TiO₂ of P25 type consisting mixture of anatase and rutile TiO₂ form.

6. The photoreactor according to claim 1, wherein said nanoparticle of TiO₂ is about 21±10 nm.

7. A photocatalystic process for degradation of pollutant in real refinery wastewater in the photocatalytic reactor in claim 1 comprises:
mixing untreated wastewater sample with required concentration of nano photocatalyst in photoreactor;
aerating said wastewater sample;
adjusting said wastewater sample with nano photocatalyst temperature;
adjusting pH of said wastewater sample with nano photocatalyst; and
said wastewater sample with nano photocatalyst is irradiated uniformly with UV light for photo-degradation of the pollutant.

8. A photocatalystic process in claim 1, wherein said nano photocatalyst is TiO₂.

9. A photocatalystic process in claim 1, wherein said nano photocatalyst size is about 21±10 nm.

10. A photocatalystic process in claim 1, wherein said temperature is set to 45° C.

11. A photocatalystic process in claim 1, wherein said pH value is set to 3.

12. A photocatalystic process in claim 1, wherein said waste water with the pollutants is irradiated with the UV light for time duration of 60-120 min.

13. A photocatalystic process in claim 1, wherein said waste water with the pollutants is irradiated with the UV light for time duration of 60 min.

14. A photocatalystic process in claim 1, wherein said concentration of nano photocatalyst is about 10-200 ppm.

15. A photocatalystic process in claim 1, wherein said concentration of nano photocatalyst is 100 ppm.
